(19) United States
(12) Patent Application Publication
(10) Pub. No.: US 2013/0259780 A1
(43) Pub. Date: Oct. 3, 2013

(54) METHOD FOR CONTROLLING SOLVENT EMISSIONS FROM A CARBON CAPTURE UNIT

(71) Applicants: Nareshkumar Bernard Handagama, Knoxville, TN (US); Barath Baburao, Knoxville, TN (US); Jayesh Naik, Houston, TX (US)

(72) Inventors: Nareshkumar Bernard Handagama, Knoxville, TN (US); Barath Baburao, Knoxville, TN (US); Jayesh Naik, Houston, TX (US)

(73) Assignee: ALSTOM TECHNOLOGY LTD, Baden (CH)

(21) Appl. No.: 13/434,957

(22) Filed: Mar. 30, 2012

(51) Int. Cl. B01D 53/62

(52) U.S. Cl. 423/220; 422/170

(57) ABSTRACT

A method and a system for controlling solvent emissions from a carbon capture unit includes passing solvent through a CO₂ absorber and a flue gas effluent stream through the CO₂ absorber and in a counter-current direction to the solvent passing through the CO₂ absorber. Subsequently, a gas-phase effluent stream from the CO₂ absorber is passed through an acid wash and the water wash to reduce an emission of solvent within a gas-phase effluent stream from the acid wash and a gas-phase effluent stream from the water wash. A control logic unit receives and processes a signal from a gas-phase analyzer and a pH sensor and passes a stream of acid wash and acid to the acid wash, and a stream of water wash to the water wash, via respective control valves.

### FIELD

The present disclosure is generally directed to apparatus and methods for reducing solvent emissions from a carbon capture process used in power generation. In particular, a control process is disclosed that provides a novel method for reducing solvent emissions in a post-combustion solvent-based carbon capture process. More particularly, the disclosure provides a new and useful technique for processing a flue gas for solvent emission reduction.

### BACKGROUND

A number of power generation stations combust fossil fuels such as coal and natural gas to produce electricity. The heat energy of combustion is converted into mechanical energy and then into electricity. Combustion emissions, commonly referred to as a flue gas, are released into the atmosphere. Such combustion emissions may comprise nitrogen oxides (“NOₓ”) and carbon dioxide (“CO₂”), as well as traces of other pollutants and particulate matter. Electricity generation using carbon-based fuels is responsible for a large fraction of the NOₓ and CO₂ emissions worldwide.

A technology for reducing CO₂ emissions from fossil fuel used in power generation is carbon capture and storage (“CCS”). Carbon dioxide emissions are controlled and captured at the point of generation, stored and transported for sequestration, and thereby prevented from being released into the atmosphere. Unfortunately, CCS consumes a high percentage of the power generated at the particular source.

Known solvent-based CO₂ capture technologies for reducing CO₂ emissions from a coal-fired or natural gas-fired boiler flue gas carry an inventory of a solvent circulating through a loop. A CO₂ absorber provides for the chemical absorption of gaseous CO₂ into the solvent from a mixed-stream flue gas. The CO₂ absorber is operated under certain conditions including ranges of temperature and pressure, turbulence, and inter-phase mixing. Subsequently, a CO₂-rich solvent stream is conditioned appropriately and is conveyed to a regenerator thereby establishing an environment conducive to CO₂ removal.

As a result of vapor pressure, equilibrium and possible degradation, an aqueous solvent releases gaseous by products including its original components in the final top stage of the absorber. Typically, a solvent effluent stream from the absorber final top stage is captured in a two-stage water wash system. The solvent effluent stream typically comprises derivatives of the solvent itself and the respective byproducts that form due to its reaction with CO₂. The water wash is employed to capture the solvent vapor by absorption in a separate water loop. Optionally, the solvent-rich water is steam-stripped in an additional stripper. Accordingly, the solvent is recovered and recycled for subsequent use in the CO₂ absorber. The described method for solvent recovery and recycle can be operationally cumbersome and can intensely increase the capital expense and the operating expense of a power plant.

### SUMMARY

According to aspects illustrated herein, there is provided a method and system for controlling solvent emissions from a carbon capture unit that includes providing a CO₂ absorber, an acid wash, and a water wash. A flue gas effluent stream from a combustion unit is passed through the CO₂ absorber and in counter-current to the solvent passing through an upper section of the CO₂ absorber to a lower section of the CO₂ absorber. Subsequently, a gas-phase effluent stream from the CO₂ absorber is passed through the acid wash and the water wash to reduce an emission of solvent within a gas-phase effluent stream from the acid wash and a gas-phase effluent stream from the water wash. Gas-phase analyzers detect the solvent level or concentration in the gas-phase effluent stream from the acid wash and the water wash, and a pH sensor monitors the pH of the acid wash. A control logic unit receives and processes a first, second, and third signal from the gas-phase analyzers and the pH sensor, respectively, and passes a stream of acid wash and acid to the acid wash, a stream of water wash to the water wash, via respective first, second, and third control valves. The above described and other features are exemplified by the following figures and detailed description.

### BRIEF DESCRIPTION OF THE DRAWINGS

Referring now to the figures, which are exemplary embodiments, and wherein the like elements are numbered alike:

FIG. 1 provides a block diagram of a prior art configuration of an arrangement of power plant flue gas processing equipment.

FIG. 2 provides a block diagram of a prior art configuration of a water wash component of a carbon capture and storage process.

FIG. 3 provides block diagram of a configuration of an acid wash component and a water wash component of a carbon capture and storage process in accordance with the present disclosure.

### DETAILED DESCRIPTION

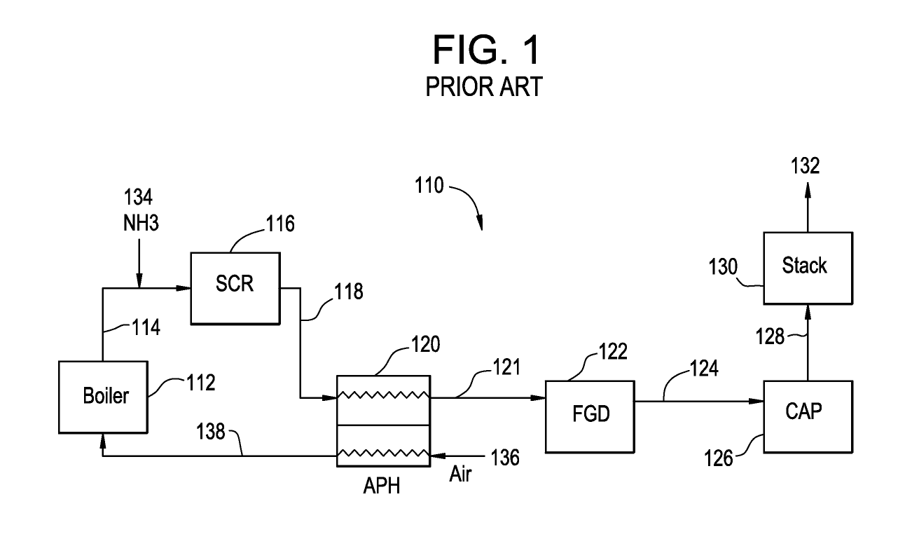

As depicted in FIG. 1, an arrangement (110) of typical prior art power plant flue gas processing equipment comprises a boiler (112) wherein a flue gas stream (114) passes from the boiler (112) into an SCR unit (116) at high temperature. An SCR unit effluent stream (118) passes from the SCR unit (116) and through an air pre-heater (“APH”) (120) and then, in turn, an APH effluent stream (121) passes into a flue gas desulfurization (“FGD”) system (122) for the reduction of sulfur oxide emissions. In the arrangement (110), a FGD system effluent stream (124) from the FGD system (122) is passed into a CCS process, such as for example, a chilled ammonia process (“CAP”) (126). A CAP effluent stream (128) from CAP (126) is released into the atmosphere via a stack (130) as a power plant emission stream (132). For effective SCR operation, an NH₃ stream (134) may be admixed with flue gas stream (114) from boiler (112) prior to entering SCR (116). For efficient boiler operation, an air stream (136) may be passed through APH (120) prior to entering boiler (112) as a pre-heated air stream (138).

Although the use of a CAP is shown and described, other post-combustion CCS processes are considered within the scope of this disclosure such as, for example, an Amine Process or an Advanced Amine Process. In these processes, the flue gas stream is treated with an aqueous amine solution which reacts with CO₂. Subsequently raising the temperature of the CO₂-rich amine solution promotes the release of CO₂ and provides for the recycling of the amine solution for reuse.

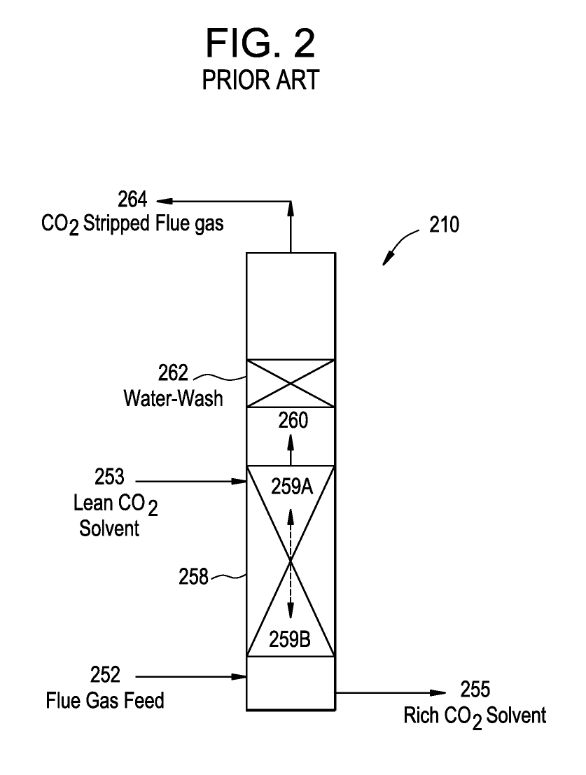

The block diagram depicted in FIG. 2 illustrates an arrangement (210) of a typical prior art water-wash system of a typical CCS process. A flue gas effluent stream (252) comprising a flue gas feed is passed to a CO₂ absorber (258) which is designed to operate with a solvent comprising of an alkaline solution. The flue gas effluent stream (252) comprises an upward flow (259A) in a counter-current direction to a flow (259B) of the solvent. A lean CO₂ solvent (253) is passed to the CO₂ absorber (258); and a rich CO₂ solvent (255) is discharged from the CO₂ absorber (258). A gas effluent stream (260) having a reduced concentration of CO₂ is passed from the absorber (258) to a water wash unit (262) where excess solvent is captured by a cold-water wash. A gas effluent stream (264) comprising a CO₂-stripped flue gas is passed from the water wash unit (262) to a stack or one or more other CCS process units.

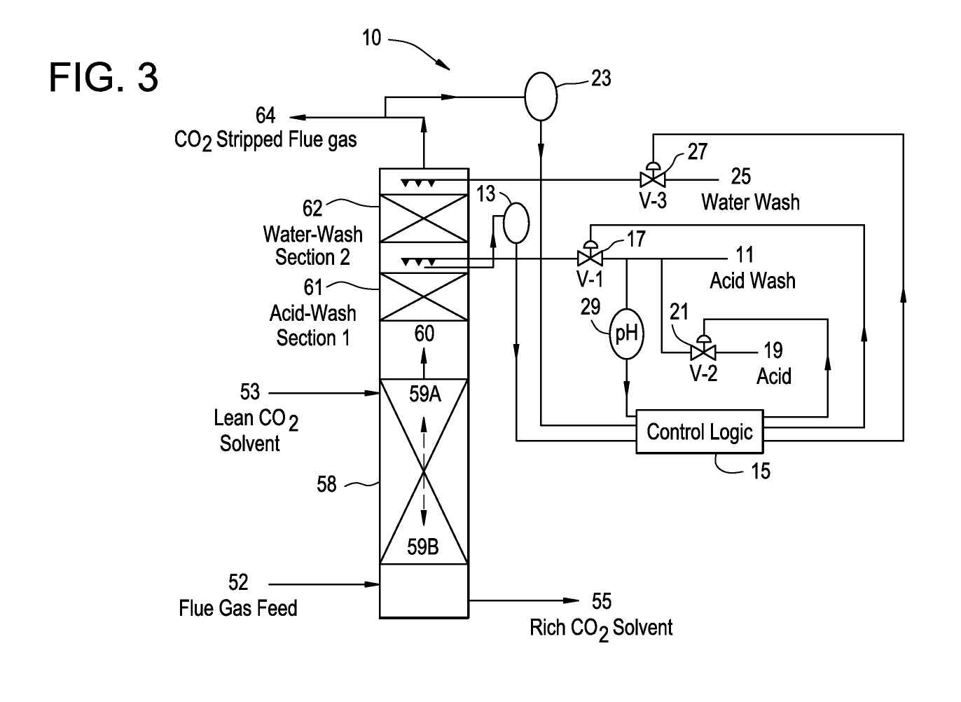

FIG. 3 provides block diagram of a configuration of an acid wash component and a water wash system of a carbon capture and storage process in accordance with the present disclosure. In an arrangement (10) of a CCS process, a flue gas effluent stream (52) comprising a flue gas feed is passed to a CO₂ absorber (58) which is designed to operate with a solvent comprising of an alkaline solution. The flue gas effluent stream (52) comprises an upward flow (59A) in a counter-current direction to a flow (59B) of the solvent whereby the solvent absorbs CO₂ from the effluent stream. A lean CO₂ solvent (53) is provided to the CO₂ absorber (58); and a rich CO₂ solvent (55) is discharged from the CO₂ absorber (58). A gas effluent stream (60) having a reduced concentration of CO₂ is passed to a first section (61) of a wash unit wherein the first section (61) comprises an acid wash. The gas effluent stream (60) is then passed from the first section (61) to a second section (62) of a wash unit wherein the second section (62) comprises a water wash. Excess solvent from the gas effluent stream is captured by both the first section (61) and the second section (62). A gas effluent stream (64) comprising a CO₂-stripped flue gas is passed from the second section (62) to a stack or one or more other CCS process units. While the placement of the acid wash has been illustrated and described as preceding the water wash, the present disclosure is not limited to such placement of these features. The present disclosure includes the placement of the water wash preceding the acid wash, for example, in a method for controlling solvent emissions comprising an amine process.

A means for detecting constituent concentrations in a gas, such as for example Gas-phase analyzers, detects the concentration of the solvent in the gas effluent stream from the CO₂ absorber and passes the detected concentration (“data”) to a control logic unit, such as for example a programmable logic controller, and the appropriate amounts of acid wash and water wash are discharged into the respective sections of the wash unit based on the data. The acid wash of the first section (61) controls solvent emissions from the CO₂ absorber (58) when acid reacts with the rising solvent in effluent stream (60). A gas-phase analyzer (13) detects the concentration of solvent in effluent stream (60) and passes the data to a control logic unit (15). Based upon a signal received from control logic unit (15), a sufficient amount of an acid wash (11) is released via a first control valve (17) and passed to the first section (61). The amount of acid wash is dependent upon the concentration of solvent detected by the gas-phase analyzer (13) and the processing of the data by control logic unit (15). The pH of the acid wash (11) is measured by a pH sensor (29) that passes the data to a control logic unit (15). Based upon a signal received from control logic unit (15), an acid (19) can be released via a second control valve (21) and added to the acid wash (11) to control the acid concentration of the acid wash.

The water wash second section (62) controls the final emissions from the CO₂ absorber (58) that will be passed to the stack or one or more other CCS process units. A gas-phase analyzer (23) detects the concentration of solvent in the effluent stream (60) and passes the data to the control logic unit (15). Based upon a signal received from control logic unit (15), a sufficient amount of a water wash (25) is released via a third control valve (27) and passed to the second section (62). The amount of water wash is dependent upon the concentration of solvent detected by the gas-phase analyzer (23) and the processing of the data by control logic unit (15).

In one embodiment of the process disclosed herein: (i) the first control valve (17) is operated in accordance with a signal received from the control logic unit (15) that is based upon the data recorded by the gas-phase analyzer (13); (ii) the second control valve (21) is operated in accordance with a signal received from the control logic unit (15) that is based upon the data recorded by the pH sensor (29); and (iii) the third control valve (27) is operated in accordance with a signal received from the control logic unit (15) that is based upon the data recorded by the gas-phase analyzer (23). While the respective control valves have been shown and described as being operated in accordance with a signal received from the control logic unit (15) that is based upon the data recorded by a respective measurement device, alternative embodiments of the disclosed process may comprise operating one or more of the control valves in accordance with a signal received from the control logic unit (15) that is based upon the data recorded from a plurality of the measurement devices or based upon a result of a programmable logic code sequence. In addition, while a gas-phase analyzer has been shown and described as means for detecting constituent concentration in a gas, the present disclosure is not limited in this regard as other types of methods such as, but not limited to, gas chromatography and quantitative chemical analysis may be substituted without departing from the broader aspects of the present disclosure.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for controlling solvent emissions from a carbon capture unit, the method comprising:
providing a CO₂ absorber;
providing an acid wash;
providing a water wash;
passing a solvent through an upper section of the CO₂ absorber to a lower section of the CO₂ absorber;
passing a flue gas effluent stream from a combustion unit through the CO₂ absorber and in a counter-current direction to the solvent passing through the CO₂ absorber; and
passing a gas-phase effluent stream from the CO₂ absorber through the acid wash and through the water wash to reduce an emission of solvent within a gas-phase effluent stream from the acid wash and a gas-phase effluent stream from the water wash.

2. The method for controlling solvent emissions from a carbon capture unit of claim 1 wherein passing a gas-phase effluent stream from the CO₂ absorber through the acid wash and through the water wash to reduce an emission of solvent within a gas-phase effluent stream from the acid wash and a gas-phase effluent stream from the water wash further comprises passing the gas-phase effluent stream from the CO₂ absorber through the acid wash and then passing the gas-phase effluent stream from the acid wash to the water wash.

3. The method for controlling solvent emissions from a carbon capture unit of claim 1 wherein passing a gas-phase effluent stream from the CO₂ absorber through the acid wash and through the water wash to reduce an emission of solvent within a gas-phase effluent stream from the acid wash and a gas-phase effluent stream from the water wash further comprises passing the gas-phase effluent stream from the CO₂ absorber through the water wash and then passing the gas-phase effluent stream from the water wash to the acid wash.

4. The method for controlling solvent emissions from a carbon capture unit of claim 1 wherein the combustion unit comprises a boiler.

5. The method for controlling solvent emissions from a carbon capture unit of claim 1 further comprising:
providing a means for detecting a solvent concentration in the gas-phase effluent stream from the acid wash and the gas-phase effluent stream from the water wash;
providing a means for detecting an acid concentration in the acid wash; and
providing a control logic unit wherein the detected solvent concentration in the gas-phase effluent streams from the acid wash and the water wash and the detected acid concentration in the acid wash are provided to the control logic unit and processed by the control logic unit.

6. The method for controlling solvent emissions from a carbon capture unit of claim 5 wherein providing a means for detecting a solvent concentration comprises providing a gas-phase analyzer.

7. The method for controlling solvent emissions from a carbon capture unit of claim 5 wherein providing a means for detecting an acid concentration in the acid wash comprises providing a pH sensor.

8. The method for controlling solvent emissions from a carbon capture unit of claim 5 wherein providing a control logic unit comprises providing a programmable logic controller.

9. The method for controlling solvent emissions from a carbon capture unit of claim 5 wherein providing an acid wash comprises providing a first control valve operable via a first signal received from the control logic unit and passing an acid wash stream through the first control valve to the acid wash.

10. The method for controlling solvent emissions from a carbon capture unit of claim 9 wherein providing an acid wash further comprises providing a second control valve operable via a second signal received from the control logic unit and passing an acid stream through the second control valve and through the first control valve and to the acid wash.

11. The method for controlling solvent emissions from a carbon capture unit of claim 10 wherein providing a water wash comprises providing a third control valve operable via a third signal received from the control logic unit and passing a water wash stream through the third control valve to the water wash.

12. A system for controlling solvent emissions from a carbon capture unit, the system comprising:
a CO₂ absorber;
an acid wash; and
a water wash;
wherein a solvent is passed through an upper section of the CO₂ absorber,
wherein a flue gas effluent stream from a combustion unit is passed through the CO₂ absorber and in counter-current to the solvent passing through the CO₂ absorber; and
wherein a gas-phase effluent stream from the CO₂ absorber is passed through the acid wash and through the water wash to reduce an emission of solvent within a gas-phase effluent stream from the acid wash and a gas-phase effluent stream from the water wash.

13. The system for controlling solvent emissions from a carbon capture unit of claim 12 wherein passing a gas-phase effluent stream from the CO₂ absorber through the acid wash and through the water wash to reduce an emission of solvent within a gas-phase effluent stream from the acid wash and a gas-phase effluent stream from the water wash further comprises passing the gas-phase effluent stream from the CO₂ absorber through the acid wash and then passing the gas-phase effluent stream from the acid wash to the water wash.

14. The system for controlling solvent emissions from a carbon capture unit of claim 12 wherein passing a gas-phase effluent stream from the CO₂ absorber through the acid wash and through the water wash to reduce an emission of solvent within a gas-phase effluent stream from the acid wash and a gas-phase effluent stream from the water wash further comprises passing the gas-phase effluent stream from the CO₂ absorber through the water wash and then passing the gas-phase effluent stream from the water wash to the acid wash.

15. The system for controlling solvent emissions from a carbon capture unit of claim 12 wherein the combustion unit comprises a boiler.

16. The system for controlling solvent emissions from a carbon capture unit of claim 12 further comprising:
a means for detecting a solvent concentration in the gas-phase effluent stream from the acid wash and the gas-phase effluent stream from the water wash;
a means for detecting an acid concentration in the acid wash, and a control logic unit wherein the detected solvent concentration in the gas-phase effluent streams from the acid wash and the water wash and the detected acid concentration in the acid wash are passed to the control logic unit and processed by the control logic unit.

17. The system for controlling solvent emissions from a carbon capture unit of claim 16 wherein the means for detecting a solvent concentration comprises a gas-phase analyzer.

18. The system for controlling solvent emissions from a carbon capture unit of claim 16 wherein the means for detecting an acid concentration in the acid wash comprises a pH sensor.

19. The system for controlling solvent emissions from a carbon capture unit of claim 16 wherein the control logic unit comprises a programmable logic controller.

20. The system for controlling solvent emissions from a carbon capture unit of claim 16 further comprising a first control valve operable via a first signal received from the control logic unit wherein an acid wash stream is passed through the first control valve to the acid wash.

21. The system for controlling solvent emissions from a carbon capture unit of claim 20 further comprising a second control valve operable via a second signal received from the control logic unit wherein an acid stream is passed through the second control valve and through the first control valve and to the acid wash.

22. The system for controlling solvent emissions from a carbon capture unit of claim 21 further comprising a third control valve operable via a third signal received from the control logic unit wherein a water wash stream is passed through the third control valve to the water wash.
